(19) United States
(12) Patent Application Publication
(10) Pub. No.: US 2024/0313351 A1
(43) Pub. Date: Sep. 19, 2024

(54) ALL SOLID STATE BATTERY AND MANUFACTURING METHOD THEREOF

(71) Applicant: SAMSUNG ELECTRO-MECHANICS CO., LTD., Suwon-si, Gyeonggi-do (KR)

(72) Inventors: Youngjin Hwang, Suwon-si, Gyeonggi-do (KR); Kyunglock Kim, Suwon-si, Gyeonggi-do (KR); Myung Jin Jung, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/021,665

(22) PCT Filed: Nov. 14, 2022
(86) PCT No.: PCT/KR2022/017829

§ 371 Date: Feb. 16, 2023

(30) Foreign Application Priority Data
Dec. 6, 2021 (KR) 10-2021-0172595

(51) Int. Cl. H01M 50/449; H01M 4/02; H01M 4/36; H01M 10/0562; H01M 10/058; H01M 50/533; H01M 50/571

(52) U.S. Cl. CPC H01M 50/449; H01M 4/366; H01M 10/0562; H01M 10/058; H01M 50/533; H01M 50/571; H01M 2004/027; H01M 2004/028

(57) ABSTRACT

An all-solid-state battery according to the present disclosure includes: an electrode layer that includes a current collector and an active material layer disposed on at least one side of the current collector; a solid electrolyte layer disposed on the electrode layer in a stack direction; and a margin insulating layer disposed laterally on an edge of the active material layer. The current collector includes a body portion on which the active material layer is disposed, and a tab portion having a smaller width than a width of the body portion and extending laterally to protrude from an edge of the body portion, and the margin insulating layer is disposed laterally on the body portion and surrounds the tab portion.

### TECHNICAL FIELD

The present disclosure relates to an all-solid-state battery and a method for manufacturing an all-SOLID-STATE BATTERY.

### BACKGROUND Art

Recently, as the down-size and long-term use of portable electronic devices is required, high-capacity of the battery is required, and the safety of the battery is required due to the spread of wearable electronic devices. Therefore, the development of an all-solid-state battery that uses a solid electrolyte instead of a liquid electrolyte is actively progressing.

Since all-solid-state batteries do not use flammable organic solvents, additional circuits for safety can be simplified. Therefore, it is expected as a technology capable of manufacturing high-capacity safe batteries per unit volume.

The above information disclosed in this Background section is only for enhancement of understanding of the background of the disclosure, and therefore it may contain information that does not form the prior art that is already known in this country to a person of ordinary skill in the art.

### DISCLOSURE OF INVENTION

### Technical Problem

One aspect of the embodiment is to provide an all-solid-state battery having a planar and stacked structure that can minimize external influences such as moisture permeation and lithium ion (Li⁺) leakage.

However, the problems to be solved by embodiments are not limited to the above-described problems and may be variously expanded in the range of the technical ideas included in the embodiments.

### Solution to Problem

An all-solid-state battery according to an embodiment includes: an electrode layer that includes a current collector and an active material layer disposed on at least one side of the current collector; a solid electrolyte layer disposed on the electrode layer in a stack direction; and a margin insulating layer disposed laterally on an edge of the active material layer. The current collector includes a body portion on which the active material layer is disposed, and a tab portion having a smaller width than a width of the body portion and extending laterally to protrude from an edge of the body portion, and the margin insulating layer is disposed laterally on the body portion and surrounds the tab portion.

The tab portion of the current collector may extend from a center of a width direction of the body portion.

The margin insulating layer may be divided by the tab portion and disposed on both sides of the tab portion in the width direction.

The margin insulating layer may surround along the edge of the active material layer.

The margin insulating layer may be stacked on the solid electrolyte layer.

The margin insulating layer may have a conductivity of 1.0×10⁻¹⁰ S/cm or less.

The margin insulating layer may include an electrolyte material or an insulating material.

The electrode layer may include a positive electrode layer and a positive electrode active material layer disposed on at least one surface of the positive current collector, and a negative electrode layer and a negative electrode active material layer disposed on at least one surface of the negative electrode current collector, and the solid electrolyte layer may be disposed between the positive electrode layer and the negative electrode layer.

The margin insulating layer may be disposed laterally on edges of the positive electrode active material layer and the negative electrode active material layer.

The positive current collector and the negative electrode current collector each may include a body portion coated with the positive electrode active material layer or the negative electrode active material layer, and a tab portion having a smaller width than a width of the body portion and extending laterally to protrude from an edge of the body portion.

The margin insulating layer may be disposed laterally on the body portion of the positive current collector and the negative electrode current collector and may surround the tab portions of the positive electrode current collector and the negative electrode current collector.

The tab portion of the positive current collector may extend from the body portion of the positive current collector in a direction opposite to a direction in which the tab portion of the negative electrode current collector extends from the body portion of the negative current collector.

The margin insulating layer may surround along the edge of the positive electrode active material layer or the negative electrode active material layer.

The margin insulating layer may include the same material as the solid electrolyte layer.

An all-solid-state battery manufacturing method according to another embodiment includes: forming a lower active material layer on a solid electrolyte layer; forming a margin insulating layer on the solid electrolyte layer to be laterally disposed on an edge of the lower active material layer; forming a current collector including a body portion disposed on the lower active material layer and a tab portion, with a width narrower than the body, extending laterally on the margin insulating layer from the body portion; and forming the margin insulating layer on an area in contact with edges of the tab portion and the body portion on the same layer as the current collector.

An all-solid-state battery manufacturing method according to another embodiment may further include: forming an upper active material layer on the current collector; and forming the margin insulating layer so as to be laterally disposed on an edge of the upper active material layer.

An all-solid-state battery manufacturing method according to another embodiment may further include forming the margin insulating layer along the remaining three edges where the tab portion is not formed in the lower active material layer, the current collector, and the upper active material layer.

An all-solid-state battery according to another embodiment includes: a cell stack including: a positive electrode layer including a positive current collector and a positive electrode active material layer disposed on the positive current collector, a negative electrode layer including a negative current collector and a negative electrode active material layer disposed on the negative current collector, and a solid electrolyte layer disposed between the positive electrode layer and the negative electrode layer; a first external electrode disposed on one side of the cell stack to connect to the positive electrode layer; and a second external electrode disposed on another side of the cell stack opposing the one side of the cell stack to connect to the negative electrode layer. The positive current collector comprises a body portion and a tab portion having a width smaller than a width of the body portion of the positive current collector and extending between the first external electrode and the body portion of the positive current collector, and the negative current collector comprises a body portion and a tab portion having a width smaller than a width of the body portion of the negative current collector and extending between the second external electrode and the body portion of the negative current collector.

The first margin insulating material may be also disposed on the tab of the positive current collector in a stacking direction of the positive electrode layer and the negative electrode layer, and the second margin insulating material may be also disposed on the tab of the negative current collector in the stacking direction of the positive electrode layer and the negative electrode layer

The all-solid-state battery may further include: a first margin insulating material disposed between the body portion of the positive current collector and the first external electrode; and a second margin insulating material disposed between the body portion of the negative current collector and the second external electrode.

The first margin insulating material may surround edge of the body portion of the positive current collector, and the second margin insulating material may surround edge of the body portion of the negative current collector.

The first margin insulating material may surround edge of the positive electrode active material layer, and the second margin insulating material may surround edge of the negative electrode active material layer.

The first and second margin insulating materials may include an electrolyte material.

The first and second margin insulating materials and the solid electrolyte layer may include the same material.

### Advantageous Effects of Invention

The all-solid-state battery according to the embodiments can minimize external influences such as moisture permeation and lithium ion (Li⁺) leakage.

The active material layer may not be exposed to the outside even when external electrodes are connected because the active material layer is surrounded with a margin insulating layer. Therefore, there is an effect that the active material layer can be protected from external influences such as moisture or Li⁺ ion leakage.

Through such an effect, the all-solid-state battery can be operated in a harsher environment, and the cycle-life can be maintained for a long time due to the effect of blocking the reaction.

### BRIEF DESCRIPTION OF DRAWINGS

FIG. 1 is a schematic cross-sectional view of an all-solid-state battery according to an embodiment.

FIG. 2 is a schematic exploded perspective view of a unit-cell stack structure of the all-solid-state battery according to the embodiment of FIG. 1.

FIG. 3 is a schematic exploded perspective view of the cell stack structure of the all-solid-state battery according to the embodiment shown in FIG. 1.

FIG. 4 is a cross-sectional view schematically showing one side of the cell stack of the all-solid-state battery according to the embodiment shown in FIG. 1.

FIG. 5 is a process diagram sequentially illustrating a cell stacking process in a manufacturing method of the all-solid-state battery according to the embodiment shown in FIG. 1.

FIG. 6 is a schematic cross-sectional view illustrating an all-solid-state battery according to another embodiment.

### MODE FOR THE INVENTION

Hereinafter, the embodiment of the present disclosure will be described in detail with reference to the accompanying drawing such that a person of an ordinary skill in the technical field to which the present disclosure belongs can easily implement. The drawings and description are to be regarded as illustrative in nature and not restrictive. Like reference numerals designate like elements throughout the specification. In addition, the attached drawing is only for easy understanding of the embodiment disclosed in this specification, and the technical idea disclosed in this specification is not limited by the attached drawing, and all changes included in the spirit and technical range of the present disclosure should be understood to include equivalents or substitutes. In addition, in the accompanying drawings, some constituent elements are exaggerated, omitted, or schematically shown, and the size of each constituent element does not fully reflect the actual size.

In addition, unless explicitly described to the contrary, the word “comprise”, and variations such as “comprises” or “comprising”, will be understood to imply the inclusion of stated elements but not the exclusion of any other elements.

Throughout the specification, the “stacking direction” refers to a direction in which constituent elements are sequentially stacked, and may be the “thickness direction” that is vertical to a wide surface (main surface) of the constituent elements on the sheet, and corresponds to the T-axis direction in drawing. In addition, “lateral direction” is a direction extending parallel to the wide surface (main surface) from the edge of the sheet-like constituent elements, and may be a “planar direction”, and corresponds to the L-axis direction in drawing.

Hereinafter, various embodiments and exemplary variations will be described in detail with reference to the drawings.

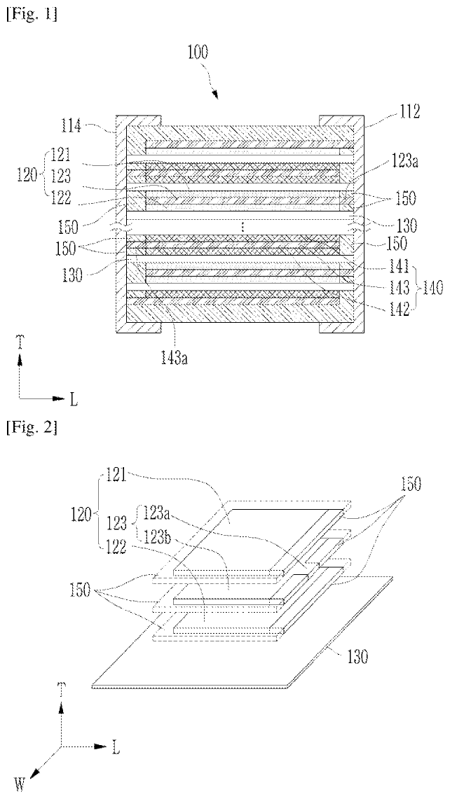

FIG. 1 is a schematic cross-sectional view of an all-solid-state battery according to an embodiment.

Referring to FIG. 1, an all-solid-state battery 100 according to the present embodiment includes electrode layers 120 and 140, and a solid electrolyte layer 130 disposed adjacent to and between the electrode layers 120 and 140 in the stacking direction. The electrode layers 120 and 140 include a positive electrode layer 120 and a negative electrode layer 140, and basically, current collectors 123 and 143 and active material layers 121, 122, 141, and 142 coated on at least one surface of the current collectors 123 and 143 may be included.

The positive electrode layer 120 is formed by coating the positive electrode active material layers 121 and 122 on at least one surface of the positive electrode current collector 123, and the negative electrode layer 140 may be formed by coating the negative electrode active material layers 141 and 142 on at least one surface of the negative electrode current collector 143. For example, the electrode layer positioned at the top of the stacking direction is formed by coating the positive electrode active material layer 122 on one side of the positive current collector 123, and the electrode layer located at the bottom may be formed by coating the negative electrode active material layer 141 on one side of the negative electrode current collector 143. In addition, electrode layers positioned between the top and bottom are formed by coating the positive electrode active material layers 121 and 122 on both sides of the positive current collector 123, or formed by coating the negative electrode active material layers 141 and 142 on both sides of the negative electrode current collector 143. The solid electrolyte layer 130 may be interposed between the positive electrode layer 120 and the negative electrode layer 140 and stacked. Therefore, the solid electrolyte layer 130 can be disposed adjacent in the stacking direction between the positive electrode active material layers 121 and 122 of the positive electrode layer 120 and the negative electrode active material layers 141 and 142 of the negative electrode layer 140. Therefore, in the all-solid-state battery 100, a plurality of positive electrode layers 120 and the negative electrode layers 140 are alternately disposed, and a plurality of solid electrolyte layers 130 are interposed therebetween to be stacked. For example, for the solid electrolyte layer 130, an LATP electrolyte (Li₁₋ₓAlₓTi₂₋ₓ(PO₄)₃ (0≤x≤0.6)) can be used. As another example, a Nasicon-based (Li₁₋ₓAlₓM₂₋ₓ(PO₄)₃) electrolyte or an amorphous (glass) electrolyte may be used as the solid electrolyte layer 130.

A margin insulating layer 150 may be disposed along edges of the positive electrode layer 120 and the negative electrode layer 140. The margin insulating layer 150 is positioned on the solid electrolyte layer 130 and may be formed laterally adjacent to the edges of the positive electrode active material layers 121 and 122 or the negative electrode active material layers 141 and 142. Therefore, the margin insulating layer 150 may be positioned on the same layer in the positive electrode layer 120 and the negative electrode layer 140, respectively.

The positive electrode layer 120, the solid electrolyte layer 130, the negative electrode layer 140, and the margin insulating layer 150 may be stacked as described above to constitute the cell stack of the all-solid-state battery 100. A protective layer may be formed with an insulating material on the top and bottom of the cell stack of the all-solid-state battery 100. In addition, terminals of the positive current collector 123 and the terminals of the negative electrode current collector 143 are exposed on both sides of the cell stack of the all-solid-state battery 100, and external electrodes 112 and 114 are connected and combined to the exposed terminals. That is, the external electrodes 112 and 114 may be connected to the terminal of the positive current collector 123 to have a positive electrode, and may be connected to the terminal of the negative electrode current collector 143 to have a negative electrode. When the terminal of the positive current collector 123 and the terminal of the negative electrode current collector 143 are configured to face opposite directions, the external electrodes 112 and 114 can also be positioned on both sides, respectively.

FIG. 2 is a schematic exploded perspective view of the unit cell stacked structure of the all-solid-state battery according to the embodiment shown in FIG. 1.

Referring to FIG. 2, the current collector 123 of the electrode layer includes a body portion 123b coated with the active material layers 121 and 122 and a tab portion 123a extending to protrude from one edge of the body portion 123b. The tab portion 123a has a width smaller than that of the body portion 123b and may extend laterally. In this case, the margin insulating layer 150 may be disposed laterally adjacent to the side of the body portion 123b and may be configured to surround the tab portion 123a.

The tab portion 123a of the current collector 123 may extend from a center of the body portion 123b in a width direction (W-axis direction). Since the margin insulating layer 150 is configured to surround the tab portion 123a, it may be divided into both sides of the tab portion 123a and disposed in the same layer as the current collector 123. In addition, the margin insulating layer 150 may be formed to have a length equal to the extended length of the tab part 123a such that the tab portion 123a does not protrude to the outside of the margin insulating layer 150.

The margin insulating layer 150 may be formed to surround the edge of the body portion 123b. That is, the margin insulating layer 150 may be disposed laterally adjacent to an edge other than the edge on which the tab portion 123a is positioned. In addition, the margin insulating layer 150 may be disposed laterally adjacent to the side along the edges of the active material layers 121 and 122 even in the layer on which the active material layers 121 and 122 are formed. Therefore, the margin insulating layer 150 adjacent to the active material layers 121 and 122 and the margin insulating layer 150 adjacent to the current collector 123 can be integrated with each other in the stacking direction.

The margin insulating layer 150 may be formed by using a material that is resistant to moisture and has low Li⁺ ion conductivity, and thus it is possible to structurally protect the active material layers 121 and 122 from moisture permeation or Li⁺ ion leakage. For example, an insulating material or electrolyte material can be applied to the margin insulating layer 150, and a material with an ion conductivity of 1.0×10⁻¹⁰ S/cm or less can be used to prevent loss of Li⁺ ions and maintain self-discharge and performance.

Referring to FIG. 2, the constituent elements constituting the positive electrode layer 120 and the margin insulating layer 150 have been described, but the coupling relationship between the constituent elements of the negative electrode layer 140 and the margin insulating layer 150 may be identically configured. However, in a structure in which terminal of the positive electrode layer 120 and the negative electrode layer 140 are drawn out in different directions, the formation positions of the tab portions 123a and 143a may be opposite to each other.

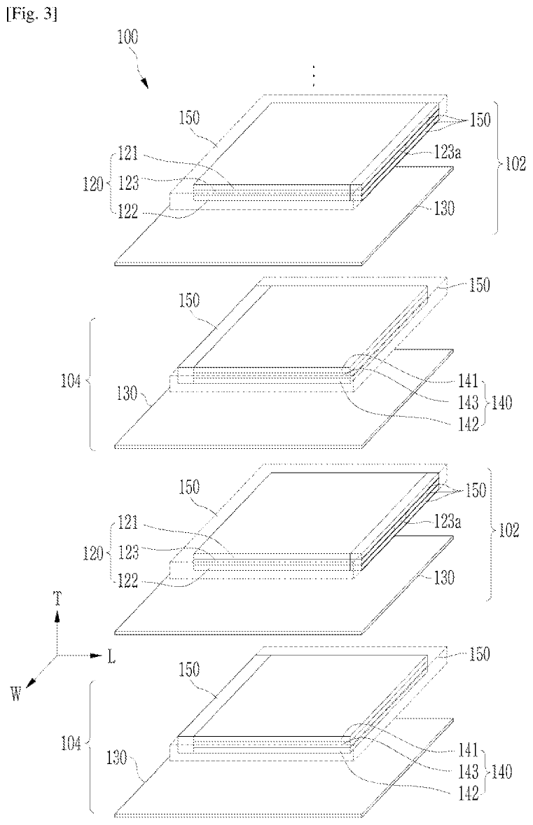

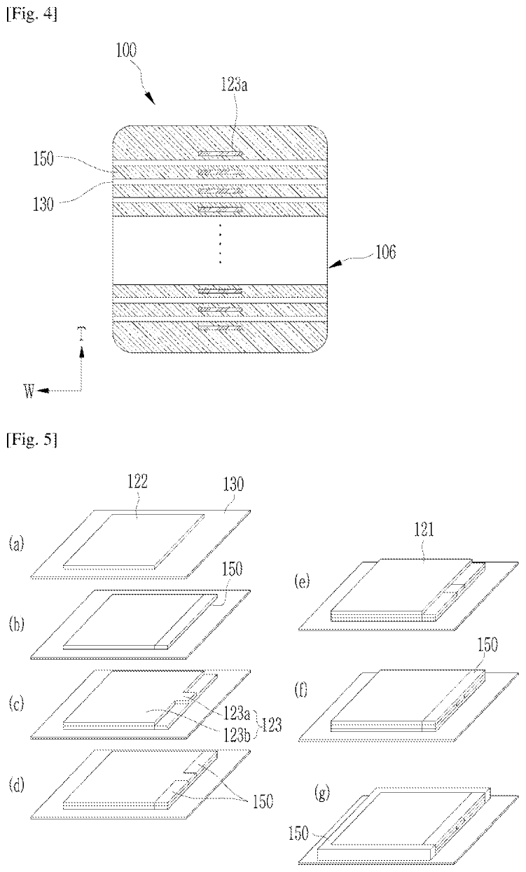

FIG. 3 is a schematic exploded perspective view of the cell stack structure of the all-solid-state battery according to the embodiment shown in FIG. 1, and FIG. 4 is a cross-sectional view schematically showing one side of the cell stack of the all-solid-state battery according to the embodiment shown in FIG. 1.

Referring to FIG. 3, in the present embodiment, the positive electrode layer 120 and the margin insulating layer 150 stacked on the solid electrolyte layer 130 become one positive electrode unit body 102, and the negative electrode layer 140 and the margin insulating layer 150 stacked on the other solid electrolyte layer 130 become one negative electrode unit body 104. When a plurality of positive electrode unit bodies 102 and negative electrode unit bodies 104 are alternately stacked and combined, a cell stack of the all-solid-state battery 100 according to the present embodiment can be formed.

Specifically, the positive electrode active material layer 122, the positive electrode current collector 123, and the positive electrode active material layer 121 are sequentially stacked on the solid electrolyte layer 130, and the margin insulating layer 150 is formed to surround edges of the positive electrode active material layers 121 and 122 and the positive electrode current collector 123 in the same layer as the positive electrode active material layers 121 and 122 and the positive electrode current collector 123 such that the positive electrode unit body 102 can be formed. In addition, in the positive electrode current collector 123. one side of the tab part 123a may be exposed without being covered with the margin insulating layer 150.

In addition, the negative electrode active material layer 142, the negative electrode current collector 143 and the negative electrode active material layer 141 are sequentially stacked on the solid electrolyte layer 130, and the margin insulating layer 150 is formed to surround edges of the negative electrode active material layers 141 and 142 and the negative electrode current collector 143 in the same layer as negative electrode active material layers 141 and 142 and the negative electrode current collector 143 such that in the negative electrode unit body 104 can be formed. In addition, in the negative electrode current collector 143, one side of the tab portion 143a may be exposed without being covered with the margin insulating layer 150.

As described above, the positive electrode unit body 102 and the negative electrode unit body 104 are stacked to form the cell stack body 106, and then, in the view from one side (WT side) to which the tab portions 123a and 143a are exposed, as shown in FIG. 4, only the edges of the tab portions 123a and 143a that are narrower than the entire width of the cell stack body 106 may be exposed. In this case, the body portions 123b and 143b of each of the positive electrode current collector 123 and the negative electrode current collector 143 are covered by the positive electrode active material layers 121 and 122 or the negative electrode active material layers 141 and 142 in the stacking direction, and are covered by a margin insulating layer 150 in the planar direction.

That is, since the positive electrode active material layers 121 and 122 or the negative electrode active material layers 141 and 142 are not exposed to the outside by the margin insulating layer 150 and only the tab portions 123a and 143a are exposed, the active material layer can be prevented from external influences such as moisture permeable or Li⁺ leakage.

FIG. 5 is a process diagram sequentially illustrating a cell stacking process in a manufacturing method of the all-solid-state battery according to the embodiment shown in FIG. 1.

Referring to FIG. 5, the positive electrode unit body formed of the positive electrode layer 120 and the margin insulating layer 150 stacked on the solid electrolyte layer 130 can be manufactured through a printing process using a paste. The positive electrode layer 120 is coated with positive electrode active material layers 121 and 122 above and below the positive electrode current collector 123, and the positive electrode current collector 123 may include a protruded tab portion 123a having a narrow width. In addition, the margin insulating layer 150 may be disposed adjacent to surround along the edge of the positive electrode layer 120 in the same layer as the positive electrode layer 120.

First, the positive electrode active material layer 122 is patterned on the solid electrolyte layer 130 and then printed (first layer printing). In this case, an area of the anode active material layer 122 is smaller than that of the solid electrolyte layer 130.

Next, the margin insulating layer 150 is formed to be laterally adjacent to one edge of the anode active material layer 122 on the solid electrolyte layer 130 (second layer printing). In this case, the margin insulating layer 150 is formed with a width extending as long as the length of one edge of the positive electrode active material layer 122, and may extend laterally from the edge of the positive electrode active material layer 122 by a protruded length of the tab portion 123a.

Next, the anode current collector 123 is patterned on the anode active material layer 122 and then printed (third layer printing). The positive electrode current collector 123 includes a body portion 123b in the same area as the positive electrode active material layer 122 and the tab portion 123a protruded laterally therefrom.

Next, the margin insulating layer 150 is printed on the area in contact with the edges of the tab portion 123a and the body portion 123b on the same layer as the positive electrode current collector 123 (fourth layer printing). In the present embodiment, the margin insulating layer 150 may be printed on both sides of the tab portion 123a on the same layer as the positive electrode current collector 123. The margin insulating layer 150 is formed to have a width extended by the remaining edge length of the body portion 123b in which the tab portion 123a is not positioned, and may extend laterally by the protruded length of the tab portion 123a.

Through the above first to fourth printing processes, the positive electrode layer having the positive electrode active material layer 122 formed on one side of the positive electrode current collector 123 can be printed, and such a positive electrode layer can be utilized as the outermost electrode layer of the cell stack.

Next, the positive electrode active material layer 121 is patterned and printed on the positive electrode current collector 123 (fifth layer printing). The positive electrode active material layer 121 may be formed to have the same area as the body portion 123b of the positive electrode current collector 123.

Next, the margin insulating layer 150 is formed so as to be laterally adjacent to one edge of the positive electrode active material layer 121 (sixth layer printing). In this case, the margin insulating layer 150 is formed with a width extending as long as a length of one edge of the positive electrode active material layer 121, and may extend laterally from the edge of the positive electrode active material layer 121 by the protruded length of the tab portion 123a.

Finally, the margin insulating layer 150 is patterned and printed along the remaining three edges on which the tab portion 123a is not formed in the positive electrode layer 120 (seventh layer printing). The margin insulating layer 150 may be printed on the solid electrolyte layer 130, and may be formed to have the same thickness as the stacking direction thickness of the positive electrode layer 120.

Although the method for manufacturing the positive electrode unit body including the positive electrode layer 120 has been described above, the method for manufacturing the negative electrode unit body including the negative electrode layer 140 may also be applied according to the described method.

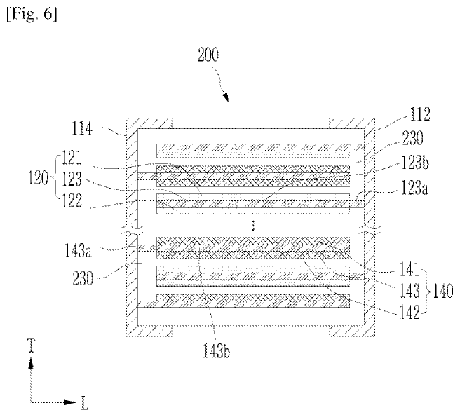

FIG. 6 is a schematic cross-sectional view illustrating an all-solid-state battery according to another embodiment.

In the all-solid-state battery 100 according to the embodiment described with reference to FIG. 1 to FIG. 5, the margin insulating layer 150 can be formed using the same material as the solid electrolyte layer 130, and this is shown in FIG. 6. Therefore, in an all-solid-state battery 200 shown in FIG. 6, a margin insulating layer and a solid electrolyte layer are not demarcated and may be formed of an integrally formed solid electrolyte layer 230.

Referring to FIG. 6, a solid electrolyte layer 230 may be disposed along the edges of the positive electrode layer 120 and the negative electrode layer 140. That is, the solid electrolyte layer 230 may be formed laterally adjacent to the edges of the positive electrode active material layers 121 and 122 or the negative electrode active material layers 141 and 142, and may be positioned in the same layer in the positive electrode layer 120 and the negative electrode layer 140, respectively.

The positive electrode layer 120, the solid electrolyte layer 230. and the negative electrode layer 140 are stacked to form a cell stack of the all-solid-state battery 200. A protective layer may be formed with an insulating material on the top and bottom of the cell stack of the all-solid-state battery 200, and the insulating material may also be made of the same material as the solid electrolyte layer 230. In one example, a dicing process may be performed so that the cell stack may be separated from a stacked structure including a plurality of the cell stacks so as to form the cell stack corresponding to that shown in FIG. 1. In addition, terminals of the positive current collector 123 and the negative electrode current collector 143 are exposed on both sides of the cell stack of the all-solid-state battery 200 after the dicing process, and external electrodes 112 and 114 may be connected and combined to the exposed terminals. That is, the external electrodes 112 and 114 may be connected to the terminal of the positive current collector 123 to have a positive electrode, and may be connected to the terminal of the negative electrode current collector 143 to have a negative electrode. When the terminal of the positive current collector 123 and the terminal of the negative electrode current collector 143 are configured to face opposite directions, the external electrodes 112 and 114 can also be positioned on both sides, respectively.

On the other hand, like the configuration described with reference to FIG. 1 to FIG. 5, the same as the described configuration, the positive electrode current collector 123 includes a body portion 123b coated with the positive electrode active material layers 121 and 122, and a tab portion 123a extending to protrude from one edge of the body portion 123b. The tab portion 123a has a width smaller than that of the body portion 123b and may extend laterally. In this case, the solid electrolyte layer 230 is disposed adjacent to the side of the body portion 123b and may be formed to surround the tab portion 123a.

In addition, the negative electrode current collector 143 includes a body portion 143b coated with the negative electrode active material layers 141 and 142, and a tab portion 143a extending to protrude from one edge of the body portion 143b. The tab portion 143a has a smaller width than that of the body portion 143b and may extend laterally. In this case, the solid electrolyte layer 230 is disposed laterally adjacent to the side of the body portion 143b and may be formed to surround the tab portion 143a.

Other constituent elements may be configured in the same manner as described with reference to FIG. 1 to FIG. 5.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

1. An all-solid-state battery comprising:
an electrode layer that includes a current collector and an active material layer disposed on at least one side of the current collector;
a solid electrolyte layer disposed on the electrode layer in a stack direction; and
a margin insulating layer disposed laterally on an edge of the active material layer,
wherein the current collector comprises a body portion on which the active material layer is disposed, and a tab portion having a smaller width than a width of the body portion and extending laterally to protrude from an edge of the body portion, and
the margin insulating layer is disposed laterally on the body portion and surrounds the tab portion.

2. The all-solid-state battery of claim 1, wherein
the tab portion of the current collector extends from a center of a width direction of the body portion.

3. The all-solid-state battery of claim 2, wherein
the margin insulating layer is divided by the tab portion and is disposed on both sides of the tab portion in the width direction.

4. The all-solid-state battery of claim 1, wherein
the margin insulating layer surrounds along the edge of the active material layer.

5. The all-solid-state battery of claim 1, wherein
the margin insulating layer is stacked on the solid electrolyte layer.

6. The all-solid-state battery of claim 1, wherein
the margin insulating layer has a conductivity of 1.0×10⁻¹⁰ S/cm or less.

7. The all-solid-state battery of claim 1, wherein p1 the margin insulating layer comprises an electrolyte material or an insulating material.

8. The all-solid-state battery of claim 1, wherein
the electrode layer comprises a positive electrode layer and a positive electrode active material layer disposed on at least one surface of the positive current collector, and a negative electrode layer and a negative electrode active material layer disposed on at least one surface of the negative electrode current collector, and
the solid electrolyte layer is disposed between the positive electrode layer and the negative electrode layer.

9. The all-solid-state battery of claim 8, wherein
the margin insulating layer is disposed laterally on edges of the positive electrode active material layer and the negative electrode active material layer.

10. The all-solid-state battery of claim 8, wherein
the positive current collector and the negative electrode current collector each comprise a body portion on which the positive electrode active material layer or the negative electrode active material layer is disposed, and a tab portion having a smaller width than a width of the body portion and extending laterally to protrude from an edge of the body portion.

11. The all-solid-state battery of claim 10, wherein
the margin insulating layer is disposed laterally on the body portion of the positive current collector and the negative electrode current collector and surrounds the tab portions of the positive electrode current collector and the negative electrode current collector.

12. The all-solid-state battery of claim 10, wherein
the tab portion of the positive current collector extends from the body portion of the positive current collector in a direction opposite to a direction in which the tab portion of the negative electrode current collector extends from the body portion of the negative current collector.

13. The all-solid-state battery of claim 8, wherein
the margin insulating layer surrounds along the edge of the positive electrode active material layer or the negative electrode active material layer.

14. The all-solid-state battery of claim 1, wherein
the margin insulating layer comprises the same material as the solid electrolyte layer.

15. An all-solid-state battery manufacturing method comprising:
forming a lower active material layer on a solid electrolyte layer;
forming a margin insulating layer on the solid electrolyte layer to be laterally disposed on an edge of the lower active material layer;
forming a current collector including a body portion disposed on the lower active material layer and a tab portion, with a width narrower than the body, extending laterally on the margin insulating layer from the body portion; and
forming the margin insulating layer on an area in contact with edges of the tab portion and the body portion on the same layer as the current collector.

16. The all-solid-state battery manufacturing method of claim 15, further comprising:
forming an upper active material layer on the current collector; and
forming the margin insulating layer so as to be laterally disposed on an edge of the upper active material layer.

17. The all-solid-state battery manufacturing method of claim 15, further comprising
forming the margin insulating layer along the remaining three edges where the tab portion is not formed in the lower active material layer,
the current collector, and the upper active material layer.

18. An all-solid-state battery comprising:
a cell stack including:
a positive electrode layer including a positive current collector and a positive electrode active material layer disposed on the positive current collector,
a negative electrode layer including a negative current collector and a negative electrode active material layer disposed on the negative current collector, and
a solid electrolyte layer disposed between the positive electrode layer and the negative electrode layer;
a first external electrode disposed on one side of the cell stack to connect to the positive electrode layer; and
a second external electrode disposed on another side of the cell stack opposing the one side of the cell stack to connect to the negative electrode layer.
wherein the positive current collector comprises a body portion and a tab portion having a width smaller than a width of the body portion of the positive current collector and extending between the first external electrode and the body portion of the positive current collector, and
the negative current collector comprises a body portion and a tab portion having a width smaller than a width of the body portion of the negative current collector and extending between the second external electrode and the body portion of the negative current collector.

19. The all-solid-state battery of claim 18, further comprising:
a first margin insulating material disposed between the body portion of the positive current collector and the first external electrode; and
a second margin insulating material disposed between the body portion of the negative current collector and the second external electrode.

20. The all-solid-state battery of claim 19, wherein
the first margin insulating material is also disposed on the tab of the positive current collector in a stacking direction of the positive electrode layer and the negative electrode layer, and
the second margin insulating material is also disposed on the tab of the negative current collector in the stacking direction of the positive electrode layer and the negative electrode layer.

21. The all-solid-state battery of claim 19, wherein
the first margin insulating material surrounds edge of the body portion of the positive current collector, and
the second margin insulating material surrounds edge of the body portion of the negative current collector.

22. The all-solid-state battery of claim 19, wherein
the first margin insulating material surrounds edge of the positive electrode active material layer, and
the second margin insulating material surrounds edge of the negative electrode active material layer.

23. The all-solid-state battery of claim 19, wherein
the first and second margin insulating materials comprise an electrolyte material.

24. The all-solid-state battery of claim 19, wherein
the first and second margin insulating materials and the solid electrolyte layer comprise the same material.
